(19) United States
(12) Patent Application Publication
(10) Pub. No.: US 2014/0298653 A1
(43) Pub. Date: Oct. 9, 2014

(54) METHOD FOR MANUFACTURING TUBE PLATE FIN HEAT EXCHANGERS

(71) Applicant: NORSK HYDRO ASA, Oslo (NO)

(72) Inventors: Jan Halvor Nordlien, Kolnes (NO); Hartmut Janssen, Hilden (DE); Thierry Guillaume, Mont Saint Martin (FR)

(73) Assignee: NORSK HYDRO ASA, Oslo (NO)

(21) Appl. No.: 14/350,883

(22) PCT Filed: Oct. 8, 2012
(86) PCT No.: PCT/NO2012/000057

§ 371 Date: Apr. 10, 2014

(30) Foreign Application Priority Data
Nov. 14, 2011 (NO) 20111564

(51) Int. Cl. B23P 15/26

(52) U.S. Cl. CPC B23P 15/26
USPC 29/890.046

(57) ABSTRACT

Method for manufacturing tube fm heat exchangers, (TFP), by brazing metal components of mainly aluminium or aluminium alloys including the following steps:—making the components of the TFP heat exchanger including the tubes (2) and plate fins (6) with collars (7),—providing a pre-braze coating with filler material on the tubes (2), or providing a (welded) clad tube (2) with a flux coating,—assembling the components including attaching the fins (6) to the tubes (2),—heating the assembled components forming the brazed connection between the tubes (2) and fins (6).

The present invention relates to a method for manufacturing tube fin (TFP) heat exchangers of aluminium or aluminium alloys.

The light weight and excellent heat transfer properties of aluminium alloys make them particularly attractive candidates for use in heat exchangers. Aluminium heat exchangers are commonly used for automotive applications. Such heat exchangers are used in air conditioning system, engine cooling system, engine oil cooling system and in automotive engine turbo-charger systems. In addition to automotive applications, aluminium heat exchangers are now to an increasing extent being used for non-automotive applications such as industrial and residential applications performing similar functions as in automotive applications.

Heat exchangers of the above tube plate fin type are most commonly mechanically assembled to obtain good mechanical connection between the fins and tube thereby as well obtaining good heat transfer between the fins and tube.

An alternative joining method which is well established for other designs of heat exchangers is brazing of aluminium.

It is as well state of the art to braze aluminium heat exchanger in a so-called CAB process which stands for Controlled Atmosphere Brazing. It is called Controlled Atmosphere as the brazing takes place under the protection of inert gas. Typically this gas is nitrogen.

CAB became popular in the early 1980's after the introduction of the potassium fluoroaluminate complexes. In order for the filler metal to bond strongly to the surfaces to be joined, the surfaces must be clean. A major problem in the brazing industry is the formation of metal oxides on the exterior of such surfaces. Aluminium, for example, oxidizes to form aluminium oxide in the presence of oxygen either from the air or absorbed on the metal's surface. Aluminium oxide has a very high melting point of about 2038° C. It neither melts nor is easily reduced to aluminium by temperatures that melt the aluminium metal itself.

A flux is a substance applied to the surfaces to be joined, and the brazing filler metal, to clean and free them from oxides and promote their union. The flux works to dissolve or otherwise remove metal oxides at the brazing temperature while not reacting with the metals to be joined. It also promotes the flow of the filler metal about and between the surfaces to be joined.

Brazing heat exchangers using the Controlled Atmosphere Brazing process relies to a large extent on:
The flux (typically potassium aluminium fluoride)
The filler or clad material (typically from AA4xxx series)
The properties of the protective atmosphere (typically nitrogen), and
The elevated temperature exposure required to melt the filler or clad material for metallic bonding.

The process parameters are modified depending on the type/size of heat exchanger to be brazed as well as the types of filler metal and flux compounds used.

Common practice for creating a metallic bond in a heat exchanger is by having one of the two components being joined to be clad with AA4xxx series (ex. clad fin and non-clad tube). A general application of flux (as defined previously) is applied to the entire heat exchanger assembly prior to brazing.

Traditionally round type plate fin heat exchangers are mechanically assembled while brazed heat exchangers are normally of the parallel flow type. For the brazed heat exchangers welded or extruded tubes are then assembled together with corrugated fin material. Within none automotive applications, mechanically assemble heat exchangers have traditionally been used especially for evaporators or split unit HX as brazed tube heat exchanges with a corrugated fin design might have a frosting issues. However, utilisation of the advantages with brazing can be done with a traditional design as well. From EP 0131444 B1 is known a round type plate fin heat exchanger and method for manufacturing the same where the heat exchanger consists of metal members in the form of fins and tubes where the metal members are made of a brazing sheet clad with a brazing material and further provided with a fluoride flux and where the metal members are connected to the tubes by heating the heat exchanger to the required brazing temperature.

In a multi material/alloy system, such as a heat exchanger, corrosion will take place on the most sacrificial par (least noble part). When manufacturing an all aluminium heat exchanger, standard practice suggest that aluminium material members should be matched so that the most critical part is protected. That is the tube should be protected from a leak throughout the life time of the heat exchanger.

For corrosion protection of brazed aluminium components, a protective layer can be used on the tube or on the whole component when required. The protective layer can in general be of the following two types:
Passive
Sacrificial

A passive layer is a coating that is chemically passive (dead) and covers the surface.

On the other hand, a sacrificial layer is a layer which is less noble than the core material. It will result in lateral corrosion when exposed to aggressive environment. A typical sacrificial layer on aluminium is the application of a zinc layer. This zinc layer can be applied to the aluminium surface by e.g. zinc arc spraying. Metallic zinc is typically applied to the surface of so called multi port extruded (MPE) tubes or micro channel tubes in line during the extrusion process. Full corrosion protection occurs after the tube has passed through a brazing cycle and a zinc diffusion gradient is formed into the tube.

As an alternative to the zinc arc spray application of zinc to an aluminium component surface as mentioned above, there is now a significant interest in using reactive Zn flux on the aluminium surface. The HYBRAZ™/® coated products containing reactive Zn flux will provide flux for brazing as well as a Zn diffusion gradient into the tube for corrosion protection. Zn flux is a so called reactive flux from potassium fluorozincate type, generating brazing flux and metallic zinc during the brazing cycle. The metallic zinc forms a Zn gradient into the Al tube as a sacrificial layer. When using Zn flux, clad fin is needed to braze the fin-tube joints.

With the present invention multiple coating variants can be derived using the HYBRAZ process:
Braze material for joint formation
Zn for corrosion protection
Si from the braze material for corrosion protection on the tube
Flux for removing the oxide layer
Li for limiting water solubility of flux residues and therefore limited attack from stationary water.

With the present invention is provided a method for manufacturing tube flat fin type heat exchanger where the fins, instead of being mechanically attached to the tube, is attached by brazing. With such inventive method according to the invention, improvements are made both with regard to more speedy and cheaper production as well as a heat exchanger with improved corrosion properties. At the same time the frosting issues seen with traditionally brazed heat exchanger (i.e. tube and corrugated fin) is avoided to a larger extent. The term tube flat fin (TFP) is her used in the same context as round tube plate fin (RTPF) but meaning any heat exchanger of this type with a tube being of any shape e.g. round, square, flat or oval.

The invention is characterized by the features as defined in the attached independent claim 1. Preferred embodiments are further defined in the subordinate claims 2-9.

The invention will now be further described in the following by way of examples and with reference to the drawings, where:

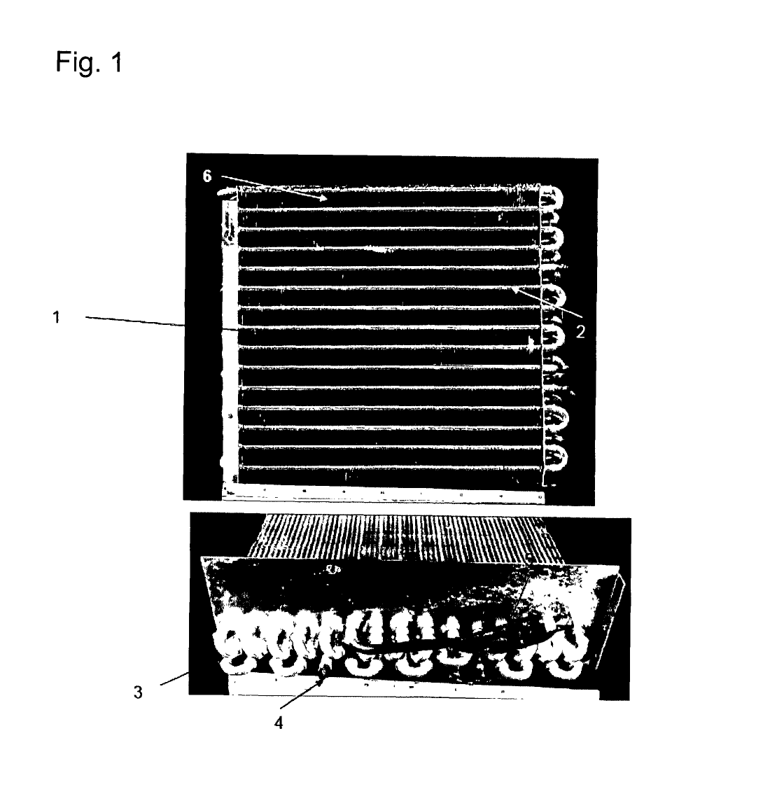

FIG. 1 shows a heat exchanger according to the invention,

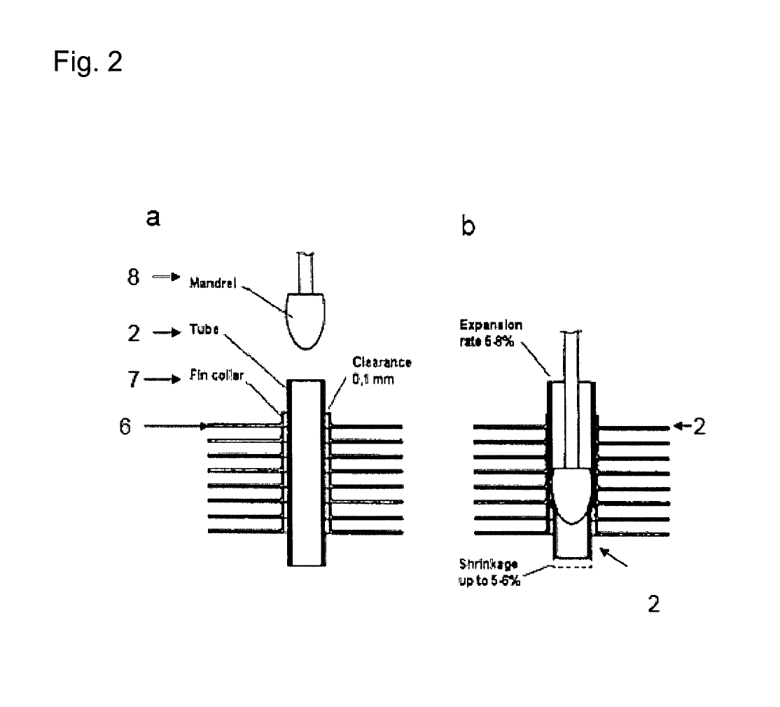

FIG. 2 shows how the fins formerly where attached mechanically to the round tube,

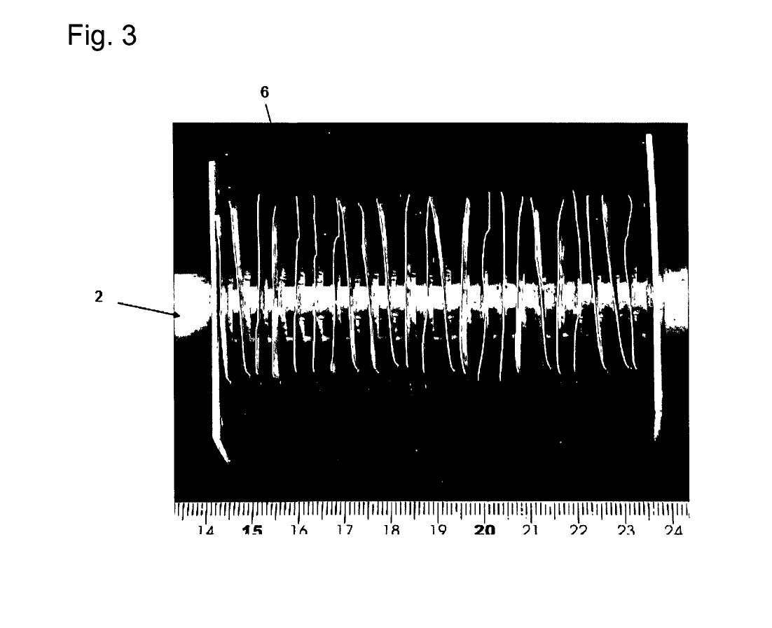

FIG. 3 shows a heat exchanger where the fins are brazed to the tubes of a heat exchanger according to the invention,

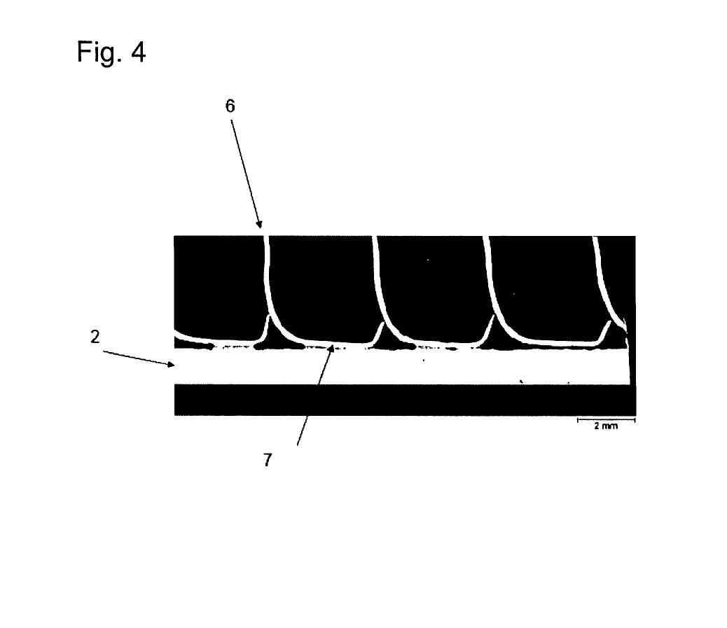

FIG. 4) shows in larger scale and cross section a part of the tubes and fins shown in FIG. 3.

A round tube fin heat exchanger (TFP) 1 according to the invention includes as is shown in FIG. 1 The hair pins 2 are the basic element of the fin and tube heat exchanger. The hair pin are inserted into a stack of fins 6. After expansion return bends are mounted and brazed 3 with connecting in-let and out-let pipe stubs 4, 5 for the circulating fluid (not shown). The tubes are in turn provided with fins 6.

As is shown in FIGS. 2 a) and b) the fins 6, each provided with a fin collar 7, are commonly attached to the round pipes by expansion of the pipes 2 such that the outer wall of the pipes are mechanically attached to the fin collars 7, The expansion is accomplished by means of a mandrel 8 being forced through each of the pipes as shown in FIG. 2 b).

In stead of using mechanical connection as is known from the prior art, the method according to the present invention is based on brazing of the fins to the round pipes of the TFP as shown in FIG. 3 and FIG. 4. Thus, the method for manufacturing the TFP heat exchanger according to the invention includes the following steps:
providing the components of the TFP heat exchanger in the form of tubes 2 and plate fins 6 with collars 7,
providing a pre-braze coating with filler material on the tubes 2, or providing a (welded) clad tube 2 with a flux coating,
attaching the fins 6 to the round tubes 2,
heating the round tubes 2 and fins 6 forming the brazed connection 8 between them.

The pre-braze coating may preferably be composed of fluxes in the form of potassium aluminum fluoride, K₁₋₃AlF₄₋₆, potassium trifluoro zincate, KZnF₃, lithium aluminum fluoride Li₃AlF₆, filler material in the form of metallic Si particles, Al—Si particles and/or potassium fluoro silicate K₂SiF₆, and solvent and binder containing at least 10% by weight of a synthetic resin which is based, as its main constituent, on methacrylate homopolymer or methacrylate copolymer.

If, in stead of a pre-flux coating with filler material, a clad tube may be used which typically may be made from an AA4xxx series alloy and the flux may typically be potassium aluminium fluoride.

The advantages with the present invention may be summarized as follows:
1. Improved corrosion protection (dense band of precipitates) on the tube, improved galvanic protection
2. Direct metal to metal to metal contact (improved heat transfer)
3. Possible reduced fin pitch? (determined by required height of collar)
4. Possible potential fin thickness reduction? (determined by needed mechanical fin strength when cleaning?)
5. HX is still a RTPF not a brazed corrugated fin solution.

With the present invention is provided a novel method for manufacturing an RTPF heat exchanger based on brazing using pre-flux coating which provides both sacrificial and passive protection and which, at the same time provides braze (filler) material for the joint formation and flux for removal of oxide layer.

Hence, the pre-flux coating according to the present invention is based on a mixture of flux particles from different fluxes with different properties, as well as Si particles as filler material and including a solvent and binder. More precisely the present invention is composed of fluxes in the form of potassium aluminum fluoride (K₁₋₃ AlF₄₋₆), potassium trifluoro zincate (KZnF₃), lithium aluminum fluoride Li₃AlF₆, filler material in the form of metallic Si particles, Al—Si particles and/or potassium fluoro silicate K₂SiF₆, and solvent and binder containing at least 10% by weight of a synthetic resin which is based, as its main constituent, on methacrylate homopolymer or methacrylate copolymer.

The potassium aluminium fluoride (K₁₋₃Al_{F4}-₆) as mentioned above may be KAlF₄ and K₂AlF₅ and K₃AlF₆ or a combination of these. This is a product from a real synthesis.

Potassium trifluoro zincate, KZnF₃ is added for corrosion protection.

The potassium fluoro silicate K₂SiF₆ reacts with Al and generates Si metal, which forms AlSi12 as filler metal. Further, lithium aluminium fluoride Li₃AlF₆ is added for limiting water solubility of flux residues and therefore limited attack from stationary water.

Correct composition is required for effect from post-braze flux residues.

For alloys with high Mg, optionally potassium aluminum fluoride (see above) plus cesium aluminium fluoride CsAlF₄, mechanically blended, may be added.

As to the composition of the coating materials, the content of solvent may preferably be approximately 30 wt % depending on the desired application properties. Further the ratio of particles and binder may vary from 3:1 to 4:1.

Additional thickener might be added to the coating material (cellulose), content approx. 14 wt % related to acrylic binder.

The ratio of particles of the different fluxes may vary as is apparent from the table below.

The coating as applied on the aluminium component may further vary with different total load between 8 g/m² and 16 g/m². See as well in this connection the table below.

TABLE
(particle content):

| | Silicon | Zn Flux | | Li Flux |
|---|---|---|---|---|
| | (Si) | (KZnF₃) | Flux (KAlF₄/K₃AlF₆) | (Li₃AlF₆) |
| | g/m² | g/m² | g/m² | g/m² |
| Ratio | 0-4.5 | 0-16 | 4-8 | 0.1-5 |
| (coating) | | | | |
| Ratio (load) | 0-5.2 | 0-16 | 2.2-9.2 | 0.1-5 |

The coating is produced by mixing based on the following sequence:
blending of solvent and binder by stirring in a suitable blender, and
adding of the flux particles to the solvent and binder composition under continuous stirring.
thorough mixing of the composition until desired quality with respect to specified parameters of the coating material is obtained.

Upon application of the coating on the components to be brazed, the coating is again subjected to stirring to guarantee a homogenous coating material. During the stirring operation viscosity of the coating is adjusted according to the application process and equipment.

Drying of coated components may take place in a separate drying process, e.g. using IR light or other heating sources.

It should be stressed that the invention as defined in the claims is not restricted to the example as described above. Thus, the coating may be blended and applied as a one layer coating or a multi layer coating.

One layer coating represents the preferred embodiment of the invention and implies that all flux components are mixed with binder and solvent and are applied in one step to the aluminium surface.

As a multi layer coating is understood that the coating is mixed as separate coatings with binder and solvent and can be applied in 2, 3 or 4 layers as follows:
2 layer coating:
   In a first layer flux, potassium aluminum fluoride, and filler material or filler generating material are applied to the aluminium surface.
   In a second layer potassium trifluoro zincate is applied.
   The coating with Li flux content can be applied either in the first or in the second layer.
The opposite direction of the two layers is possible too, with potassium trifluoro zincate as first layer.
3 layer coating:
   Each component is applied as a single coating layer.
   Flux coating layer
   Filler material or filler generating material coating layer.
   Potassium trifluoro zincate coating layer.
   The Li content can be applied within each of the coating layers
4 layer coating:
   Each component is applied as a separate coating layer as with the 3 layer above, but
   The Li content is applied as a single layer as well.

In the case of a multi layer coating it will be important to control the total amount of binder to avoid any trouble from too high content of organic resin and therefore trouble in brazing.

In case of a multi layer coating some of the layers might be discontinuously applied.

As to how the pre-flux coating may be provided on an aluminium component, any technique may be used such as roll coating, dip coating, spray coating or even screen printing.

1-9. (canceled)

10. Method for manufacturing tube fin (TFP) heat exchangers by brazing metal components of mainly aluminium or aluminium alloys including the following steps:
making the components of the heat exchanger including the tubes and plate fins with collars,
providing a pre-braze coating with filler material on the tubes, or providing a (welded) clad tube with a flux coating,
assembling the components including attaching the fins to the tubes,
heating the assembled components forming the brazed connection between the tubes and fins.

11. Method according to claim 10, wherein the coating is composed of fluxes in the form of potassium aluminum fluoride K₁₋₃AlF₄₋₆, potassium trifluoro zincate, KZnF₃, lithium aluminum fluoride Li₃AlF₆, filler material in the form of metallic Si particles, Al—Si particles and/or potassium fluoro silicate K₂SiF₆, and solvent and binder containing at least 10% by weight of a synthetic resin which is based, as its main constituent, on methacrylate homopolymer or methacrylate copolymer.

12. Method according to claim 10, wherein the coating is blended as a one layer coating or a multi layer coating, whereby as a one layer coating all flux components and filler material are mixed with binder and solvent, and whereby as a multi layer coating the flux components and filler material are mixed as separate coatings with binder and solvent.

13. Method according to claim 10, wherein the multilayer coating includes 2, 3 or 4 individually blended coating elements each based on binder and solvent with one or more flux component and/or filler material or filler generating material.

14. Method according to claim 10, wherein the potassium aluminum fluoride, K1-3 AlF₄₋₆ is a flux including KAlF₄, K₂AlF₅, K₃AlF₆ or a combination of these fluxes.

15. Method according to claim 10 where the aluminium component is based on an aluminium alloy with high Mg content, wherein an additional flux in the form of cesium aluminum fluoride CsAlF₄ is added.

16. Method according to claim 10, wherein the ratio of particles and binder is between 3:1 to 4:1.

17. Method according to claim 10, wherein the ratio of particles of the different components of the coating corresponds to a load of 0-5.2 g/m² Si, 1.41-16 g/m² Zn flux (KZnF₃), 2.2-9.2 g/m² potassium flux (KAlF₄/K₃AlF₆) and 0.1-5 g/m² Li flux (Li₃AlF₆) g/m².

18. Method according to claim 10, wherein the coating is provided on the component by spray coating or dip coating.
